(19) United States
(12) Patent Application Publication
(10) Pub. No.: US 2021/0112064 A1
(43) Pub. Date: Apr. 15, 2021

(54) SYSTEMS AND METHODS FOR PHYSICAL ACCESS CONTROL

(71) Applicant: BIOCONNECT INC., Toronto (CA)

(72) Inventors: Elena LOSSEVA, ON (CA); Courtney Ryan GIBSON, Toronto (CA); Robert DOUGLAS, Toronto (CA)

(21) Appl. No.: 16/653,152

(22) Filed: Oct. 15, 2019

(51) Int. Cl. H04L 29/06

(52) U.S. Cl. CPC H04L 63/102; H04L 63/08

(57) ABSTRACT

A system and methods for interpreting a user's movement through space as a passive behavioural biometric is described. Using patterns of user's movement through space, the system detects anomalies in user movement, provides or restricts access to a restricted space without adding extra friction to the user, and generates risk events. An adjacency matrix (i.e., footprint) is generated by analyzing a user's movement through space and creating a weighted directed graph for the user. Anomalies are detected by comparing a user's footprint against the same user's earlier footprint, or the footprints of other users within a group, or the footprints of all other uses in the system.

### FIELD

Embodiments of the present disclosure generally relate to the field of security identification and authentication, and more specifically, security identification and authentication for access control based at least on tracked movements or physical access events.

### INTRODUCTION

Controlling physical access in respect of individuals at various locations and facilities may be desirable, especially where there are security or privacy considerations. For example, a secured facility may have access restricted only to contractors and employees, or an educational facility restricts access only to students and teachers to avoid overcrowding of lecture halls.

Existing approaches for physical access control include the use of badges that may be used to validate a user at a door (e.g., a secured revolving door), and may activate a securement mechanism such as a magnetic door latch. There are other approaches to validation, such as the use of fingerprints or retinal scans. However, these approaches are inconvenient for users, especially in high volume or high throughput junctions. For example, for students at a learning institution, there may be a large rush of students before classes start and after classes end. In these situations, existing approaches are impractically unfeasible due to the need for active authentication.

Physical premises security is being of greater importance, especially in relation to data centers or facilities holding data centers. Sensitive, customer information may be stored therein, and the physical locations can be placed in sprawling, suburban campuses where, while having employee friendly elements, such as large green spaces, accessible parking lots, etc., there are potential areas of ingress by malicious parties. A malicious party may further attempt to impersonate an employee by stealing or cloning the employee's passcard or other authentication device (e.g., security token).

### SUMMARY

Systems, methods, and computer program products (non-transitory computer readable media storing machine-interpretable instructions) are described for passive authentication for measuring trust using physical access event analytics. In particular, controlling access to a controlled resource is conducted using tracked physical access as a passive biometric to track movement through space. The system described can be used in the above situation where a passcard or other security token is stolen and being used by a malicious user.

The tracked physical access can include, for example, security events recorded by an access management system (AMS), such as door badge access entry points that have been used for authentication of the individual at various junctures. In some embodiments, geolocation mechanisms, such as beaconing or triangulation technologies are utilized to track the movement of the individual or a corresponding device (e.g., smartphone).

In a naïve AMS, an individual with a stolen passcard or security token may otherwise have access to the entirety of the system. An improved system is described herein that seeks to balance convenience of use and available computational processing power to be able to provide an increased technical security layer. In more specific embodiments, an improved data structure and transformations thereof are described that can be generated and consumed to provide a computationally feasible solution that is able to provide outputs reasonably quickly such that they can be actioned on, typically in a passive manner (such that the system is otherwise invisible to the user unless a potential security event is indicated, at which time security can be summoned, an alarm is generated, or a step up authentication is required).

A technical challenge that arises when attempting to perform authentication based on these data sets is that the data sets do not translate directly to outputs indicating whether an individual is likely to be trustworthy or not. This problem is further complicated by scalability issues as a system can be monitoring and generating estimates for a large number of individuals, often simultaneously or near simultaneously. As noted, this system can be used, for example, in a high-volume, high throughput facility.

The approach proposed herein provides a computational approach that attempts to utilize historical access attempt data or movement data to establish a passively tracked mechanism for authentication of an unverified user, using passive behavioural biometric authentication. In certain situations, the passive behavioural biometric authentication can be combined with active authentication approaches, for example, in a “step up” challenge where sufficient trust cannot be established. This can be particularly useful, for example, where the unverified user is estimated to be suspicious by the system, or is attempting to enter an area of increased security requirements. The prior movements and data sets of similar users is used to create an improved data structure that can be maintained over time and can be used for computationally practical comparisons with individual level, population level, or group level templates.

Group level templates can be established for different groups of people, or different activities within groups (e.g., sub-groups). For example, a nurse practitioner may be tasked with conducting an emergency intervention in relation to an allergic reaction. The nurse practitioner badges into various equipment closets to obtain tools (e.g., antihistamines, steroids, surgical tools). A graph data structure is maintained over time for nurse practitioners responding to allergic reactions (e.g., the system may not require specific training from a human, but rather, the data structure populates and fidelity is obtained, for example by checking the population size of examples versus a standard deviation).

A malicious person, having stolen the passcard of the nurse practitioner, then enters a closet storing controlled drugs, such as opioids. When the malicious person attempts to use the badge at this closet, the distance continues to increase. As the malicious person continues to move around the facility, taking steps that would not normally be taken by the nurse practitioner in this context (e.g., opening a rear door entrance, heading to a floor not related to care of patients who are suffering from allergic reactions). The system may passively track the nurse practitioner and raise an alarm or security incident. The nurse practitioner may receive a step up authorization (e.g., a call to a mobile device requesting the input of a code word, such as “evergreen”, only known to the nurse practitioner). If the step up authorization fails, security is alerted as there may be a person posing as the nurse practitioner on the premises.

Traditionally, a user attempting to enter a secured location with strong authentication protocols would be required to engage in two-factor authentication. For instance, the user may be required to use a badge and then perform a fingerprint verification at a reader before being granted access into the space. While this approach satisfies the requirements for strong authentication, it also introduces technical problems in the form of friction points which involve time and energy from the user. A benefit of the passively tracked authentication is that the friction points can be avoided, in some situations.

For example, a security layer may be established by tracking movement patterns (e.g., as tracked through data sets of attempted entry at various access control points). The unverified user badges into various access control points, and is granted or denied access accordingly. The security layer operates by establishing walks through a directed graph, stored in a data structure and periodically/continuously updated, based on the data sets. The directed graph can include nodes for access points, and edges indicating interconnection areas where individuals are able to move between the access points without further authentication (e.g., a front gate A can have an edge connecting front door B as well as another edge connecting warehouse garage door C).

The walks are represented as weights on the directed graph, such that the walks are used to generate adjacency matrices that can be periodically updated as templates for comparison. The walks are not necessarily unidirectional and may have overlap and/or loops, and can be representative of sequential access attempts (e.g., a user may backtrack many times during the course of a duration of time). The walks may be tracked across various durations, such as across an entire workday, for the morning entry, during lunch, etc.

These template data structures can be used to establish various types of reference baselines for comparison, including, for example, a 1:1 matching attempt (is this Alice?), a 1:group matching attempt (is this a member of the IT team?), or a 1:n matching attempt (does this person work in this building?).

The reference adjacency matrices can be stored on various profiles or group-level profiles stored in data storage, and can be updated periodically. In some embodiments, the reference adjacency matrices are maintained for individual verified user profiles, and then transformed and/or combined together to establish the 1:group templates or the 1:n templates. For example, a 1:group template can be generated based on an aggregated version (e.g., an averaged version) of adjacency matrices for the IT team that are transformed into a single template representative of an average member of the IT team. Similarly, a number of templates can be aggregated to form a reference template representative of an average student eating in a cafeteria.

A challenge with these types of approaches is the computational burden from continuously generating estimates and authentications, and specific approaches are described herein that are specially adapted for reduced computational processing requirements and efficient approaches for evaluating magnitudes of differences between different adjacency matrices. Computational speed is of importance, especially where passive, on-going security is being established. Some further embodiments are directed to computational approaches to tracking a measure of variance (e.g., fidelity) to approaches which can be used to improve accuracy by reducing false positives (e.g., an individual has a large level of variability in entrance pathways to the facility, and the data structure can reflect this such that upon processing for verification, a greater leniency is afforded to deviations from a most commonly used walk).

The system described herein provides for the automation of at least one of the authentication protocols that can be used at a facility. The system improves on current computer technologies providing a novel computational approach of interpreting a user's movement through a space, tracked using data derived from at least the user's access at physical access points, and utilizing said data as a passive behavioural biometric protocol using improved data structures specially adapted for computational approaches.

The approach described herein includes receiving, at an input interface, a first data set indicative of tracked physical access events associated with a user or a group of users. The first data set includes physical access authentication events (e.g., user A traverses gate X, revolving door Y, server room door Z around 7:45 AM-8:15 AM, Monday to Friday), tracked geolocations (e.g., from beaconing technology between a smartphone and corresponding sensors/transceivers), among others. The first data set may include historical data for the user (e.g., in a user profile) or a group of users (e.g., in a group profile, indicative of students generally, IT server room workers in the server image test team).

The first data set is processed by a template generation engine to generate an identity template that allows comparing historical data for a user against future authentication attempts. The identity template, for example, in the group context, may be based on an aggregate of the users belonging to a group, and may be used for verification by establishing a distance compared to an aggregated perspective of someone belonging in a particular group.

During authentication or verification, an input interface receives a second data set indicative of tracked physical access events or movement data associated with an unverified user. The second data set may include a set of movements or tracked activity access attempts (succeeded or failed) for a period of time.

A challenge template is generated by a template generation engine from the second data set, based at least on the tracked physical access events or movement data associated with the unverified user. For example, this includes doors attempted to access so far, among others (e.g., front gate, side door 1, side door 2). The challenge template can, in some embodiments, be a compressed representation or a vector representation including a number of raw or transformed features.

The challenge template is processed against the identity template to determine a degree of similarity (e.g., an edit distance based on Levenshtein distances), and a control event is caused based at least on the degree of similarity. For example, if responsive to a determination that the degree of similarity is not within a bounded threshold, generating a control signal restricting access to the controlled resource. Conversely, if the degree of similarity is within a bounded threshold, an access grant decision is initiated or a level of authentication is reduced.

The verification and the templates may be generated at a 1:1 level (e.g., is this individual X compared against historical individual X), a 1:n level (individual X compared against group members), or a 1:m level (individual X compared against all tracked access attempts). Furthermore, in variant embodiment, the system receives the data set relating to the unauthenticated person, and generates an estimation of what group or what person the unauthenticated person's data resembles.

Access attempts between 1:n and 1:m users may be based, for example, on an adjacency matrix to 300 others that is evaluated based on edit distances established between data points. Where historical events are being used for the first data set, the identity template may represent and be continuously updated as a rolling average, for example.

The generating of the identity template or the generating of the challenge template includes, for example generating a corresponding weighted directed graph by a weighted graph generation engine G=(V,E) where V is a set of vertices (v1,v2)∈E each corresponding to access control points and E is a set of ordered pairs of vertices established if and only if an individual can travel between two access control points without authenticating at any other access control points. The graph is used to generate a walk along some of the edges established across the nodes of the weighted graph.

The degree of similarity is established by determining an edit distance between the walk corresponding to the identity template and the walk corresponding to the challenge template, and the edit distance is determined based at least on a Levenshtein distance.

In a further embodiment, the control signal restricting access to the controlled resource invokes a step-up authentication for the unknown user based on a separate authentication modality. For example, a password may be requested or additional fingerprint verification might be required just for that individual, or more passive modalities may need to be consulted (e.g., gait, angle/orientation of devices when presenting to a reader, movement velocity).

The system, in some embodiments, is a physical server or computing device that interoperates with computer memory and storage media. Computer programs can be stored thereon non-transitory computer readable media which include machine-interpretable instructions that, when executed, cause processors to perform methods described herein for passive security. The passive security functionality can include the use of specific data structures and computational approaches to help ease the computational burden through more efficient representations of movements and comparisons. As noted above, this is especially useful if the identity of the user is not known and the system is instead running 1:m (group) or 1:n (full population) level comparisons periodically. The data structures can be periodically updated such that as the user (and other users) access different points of secured entry, their tracked activities can be used to improve an overall accuracy level of the system.

The system can be integrated with points of secured entry such that the devices (e.g., card readers, man traps, beacons, computer logins) are electronically coupled such that data sets can be provided to populate the data structures. If a user deviates from either the 1:1, the 1:m, or the 1:n matching (e.g., by proxy through the distance determined between data structures), the system can generate alarms or notifications, or in some cases, trigger or invoke a “step up” authentication functionality (e.g., on the user's phone) before security is requested.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example user's movements throughout a day, according to some embodiments.

FIG. 2 is a block schematic diagram of a second example user's movements throughout a day, according to some embodiments.

FIG. 3 is a weighted directed graph of an example user's movement throughout the day, according to some embodiments.

FIG. 4 is a weighted directed graph of a second example user's movement throughout the day, according to some embodiments.

FIG. 5 is a diagram of an adjacency matrix, according to some embodiments.

FIG. 6 is an example of two adjacency matrices that may be compared using the system, according to some embodiments.

FIG. 7 is an example adjacency matrix of the computed distance between users, according to some embodiments.

FIG. 8 is an example algorithm used to detect anomalies in or near real time, according to some embodiments.

FIG. 9 is a method diagram describing the method by which the system detects anomalies, according to some embodiments.

FIG. 10 is a graphical rendering of an administrative interface, according to some embodiments.

FIG. 11 is a block schematic diagram of the system, according to some embodiments.

### DETAILED DESCRIPTION

The embodiments disclosed herein present an improved system and methods for authentication that combine active authentication with passive biometric measures to regulate access to a controlled resource and provide strong authentication with minimal friction for the user.

The system described herein provides for the automation of at least one of the authentication protocols currently performed by such a user. The system improves on current computer technologies beyond simply organizing information into a new form by providing a novel way of interpreting a user's movement through a space, tracked using data derived from at least the user's access at physical access points, and utilizing said data as a passive behavioural biometric protocol.

Strong authentication traditionally assumes that there at least two factors of authentication used during an identity verification event: something you know, something you have, or something you are.

Many organizations today rely on strong authentication protocols to regulate access into spaces, such as buildings, and often times, different floors or areas within a space may have different levels of authentication protocols in place.

Strong authentication typically relies on two-step authentication protocols. An example of two-factor authentication for a physical access event is using a badge (something you have) and then performing a fingerprint verification at a reader (something you are). For instance, due to the high-stakes nature of their job, airline pilots may be required to authenticate first at the gate, using an identification card or fingerprint scan (something they have or something they are) and again prior to entering the cockpit, via a pin pad (something they know).

Some hospitals require doctors and nurses to input an access code before being granted access to an operating room. Within the physician and nurse group of a hospital, only surgeons and operating room nurses have knowledge of the access codes for these operating rooms.

This is a second authentication protocol in addition to all staff being required to authenticate at a first access point, such as the entrance to the back-end of the hospital, using, for example, a badge or pin code. In contrast, the employee lunch room of the hospital would be open to all hospital employees and access would be granted by tapping a badge against a badge reader. The reception area of a hospital is generally open to both employees and non-employees (e.g., patients), and would not require authentication of any kind prior to access.

Other organizations, such as banks and financial institutions, rely on biometrics to identify employees and secure data. For instance, a bank may rely on fingerprint scanning technology to identify whether a particular employee should be allowed access into a restricted area. As an example, banks typically create barriers between different divisions in order to prevent conflicts of interest. An investment banker may thus be prohibited from entering the equity research floor of a bank without special permission so as to maintain the bank's integrity. This physical separation can be achieved by requiring that employees authenticate prior to entering the investment banking floor and the equity research floor through at a fingerprint scanner. Upon receiving an employee's fingerprint information, the scanner system would determine whether that employee may be permitted to enter a restricted floor.

While the approaches above satisfy the requirements for strong authentication, they also introduce technical problems in the form friction points.

For instance, requiring that users engage in two-step authentication adds an extra layer of inconvenience and friction for the users because it requires that they engage in two separate active actions (e.g., tapping a badge at a card reader for entrance in to a first area such as the hospital clinic, back-end of a bank, or the gate of an airport, and then scanning a fingerprint or inputting a number into a pin pad prior to entering the operating room, a specific floor of the bank, or the cockpit) in order to authenticate. Furthermore, it may create scalability problems because installing biometric readers at every door can be expensive and labor intensive. Also, the logistics of enrolling every employee's biometrics in a system requires additional time and resources.

With those concerns in mind, the disclosure presented herein presents a technical solution to the issue above and is an alternative approach to satisfying requirements for strong authentication through the use of passive biometrics. As described in some embodiments herein, a person's movement through physical space may be interpreted as a passive behavioral biometric and serve as one of the two-step authentication protocols.

For example, in the case of a hospital using the system disclosed herein, the surgery staff would not be required to authenticate twice—upon entering the back-end of the hospital and then again prior to entering the operating room. Instead, the system would monitor a surgeon's movements throughout the day by tracking their authentication at first-step access points (such as the general hospital area or the hospital cafeteria) and compute whether their movements are similar to that same surgeon's prior movements from prior days, or to other surgery staff, or to hospital personnel in general, to decide whether that surgeon may be granted access into the operating room without the need to input a pin code or undergo a fingerprint scan as a second authentication protocol.

In the example above, the system would monitor the surgeon's movements: first, the surgeon would enter through an access point such as a clinic/back-end door of a hospital that requires authentication and would tap their badge to authenticate at a terminal. The terminal would employ a communication protocol, such as near-field communication, to read the badge and transfer encrypted data on that badge to a central administration engine. The central administration engine would analyze said data and assess whether the surgeon is to be granted access through this access point. The present disclosure retrieves data from the central administration engine and may store it for later retrieval. Upon retrieving said data, the disclosure instructs a template generation engine to generate an identity template for the surgeon containing personal information about the surgeon retrieved from encrypted data on their badge, such as name, date of birth, department in which the surgeon works, and access point data, such as which doors the surgeon has tried to access and which of those attempts were successful.

Table 1 below shows an example of data that may be collected by the system.

| Employee Name | Time Stamp | Door (Reader) | Access |
|---|---|---|---|
| Jamieson, Tom | Feb. 10, 2016 22:16 | NAP7 Office MT | Verify Fail |
| | | Turnstile Ent | |
| Jamieson, Tom | Feb. 10, 2016 22:16 | NAP7 Office MT | Verify Fail |
| | | Turnstile Ent | |
| Jamieson, Tom | Feb. 10, 2016 22:16 | NAP7 Office MT | Verify Fail |
| | | Turnstile Ent | |
| Jamieson, Tom | Feb. 10, 2016 22:16 | NAP7 Office MT | Success |
| | | Turnstile Ent | |
| Huff, Frederic | Feb. 10, 2016 22:34 | NAP9 Receiving | Success |
| | | Passage Ent | |
| Torres, Giovanni | Feb. 10, 2016 22:59 | NAP9 Receiving | Success |
| | | Passage Ent | |

As the surgeon moves about their day, they may come in contact with other access points, such as the doors to a library or cafeteria reserved for employees. These incidences are logged as described above and the surgeon is granted access.

In an embodiment, by examining raw data, such as the data in example Table 1, the system can identify features that are specific to an individual, such as when a person typically starts a shift, which entrance door they used to enter the campus, which days of the week they work on. For instance, in Table 1 above, the system computes an identity template for Fredric Huff as follows:

Workdays: Tue, Wed, Thu, Sun, Mon (takes Fridays and Saturdays off)

Shift start time (typical): 10:30 pm

Shift lasts until about 5 am (last badging event)

Entrance door: NAP9 Receiving Passage Ent

Typical number of badging events per shift (average): 11.1

Number of unique doors accessed per shift (average): 5.4

In an embodiment, data recorded in an individual's identity template may be used for comparison purposes against a challenge template to identity anomalies.

In the example above, assuming that the surgeon attempts to enter a higher-security area that would traditionally require a second authentication protocol, such as an operating room. At this subsequent access point, the surgeon taps their badge again for authentication purposes and data is sent to the central administration engine as described before. The system fetches said data and instructs the template generation engine to generate a challenge template. The challenge template contains similar information to the identity template, but is used to assess whether the surgeon should be granted access to this higher-security area by comparison with the surgeon's own identity template from prior days or earlier the same day, or against the identity templates of other surgical staff, or against the identity templates of all hospital employees.

The template generation engine engages a weighted graph generation engine, which uses the surgeon's access point information from the surgeon's template to generate a weighted directed graph using formal notation from graph theory to represent the surgeon's movements through space. Then, the disclosure engages an adjacency matrix generation engine to transform the weighted directed graph into an adjacency matrix.

Once an adjacency matrix has been created for both the surgeon's identity and challenge templates, the disclosure assesses the level of similarity between the identity and challenge adjacency matrices and compares the results against a threshold level to decide whether the surgeon should be granted access into the operating room without requiring a second form of authentication.

If an anomaly arises, the disclosure generates an alert to notify the central administration engine that an intruder may be attempting to enter the operating room and prompt the central administration engine to request step-up authentication of the potential intruder through, for example, requiring that the intruder input a pin number sent to the surgeon's phone number or engage in biometric authentication such as fingerprint scanning prior to access being granted.

In an embodiment, alerts are generated at an output interface.

There are several potential advantages to the technical solution disclosed herein. For instance, access event data is available for all doors, not just those equipped with biometric readers, thus eliminating the need for additional expense and labor. Furthermore, patterns of user behavior may be used to detect anomalies in user access, without adding extra friction to the users. Unlike the two-step authentication above, the disclosure presented herein relies on the user's passive behaviour, eliminating friction. Also, multi-factor authentication is supported at all doors.

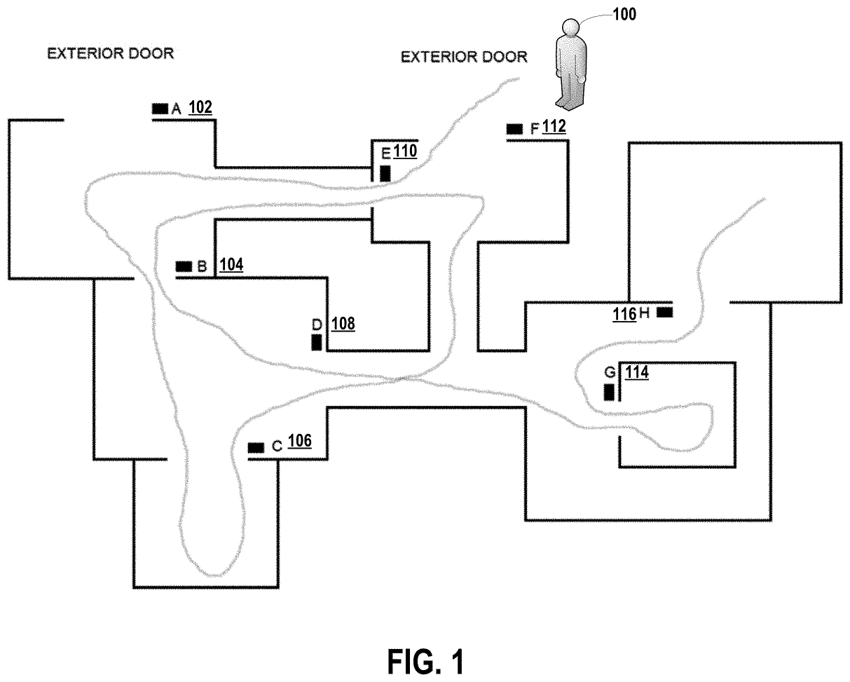

FIG. 1 is a block schematic diagram of an example user's movements throughout a day, according to some embodiments.

In an embodiment, a user 100 engages in a series of tracked physical access events throughout a day as the user 100 moves through a controlled resource. A controlled resource is a physical space to which access is restricted to only some individuals, such as an office building, school campus or cafeteria. In this example, the user 100 begins their shift by authenticating by, for example, tapping their badge or mobile phone at a designated access control entry point (such as a door or turnstile), and enters the space through door F 112, followed by sequential authentications at doors E 110, B 104, C 106, D 108, E 110, B 104, D 108, G 114 and H 116. In this example, doors A 102 and F 112 are exterior doors used to enter and exit the premises.

In an embodiment, the tracked physical access event involves a badging event whereby the user holds a contactless smart card near a terminal employing for example, near-field communication (NFC) protocols to enable the user's identification. The smart card may store an encrypted digital certificate holding relevant information about the user, such as the user's name, age, height, office location, amongst others. On proximity, the terminal transfers encrypted digital certificate data to a central administration engine via for example, NFC technology. A processor within the central administration engine analyzes data received at each access point and assesses whether the user should be granted access through the access point in or near real time.

In another embodiment, the tracked physical access event may comprise of door access, motion sensor triggers, geolocation-based events, or biometric security screening such as a fingerprint scanner, amongst others.

In an embodiment, the central administration engine transfers a data set, such as encrypted digital certificate data received at each of doors F 112 through H 116, in sequential order of authentication, to a second processor at an input interface. The data set may include at least one data field representative of individual name, time stamps, door reader access events, or challenge success. The second processor instructs a template generation engine to generate an identity template from the data set received at the input interface.

The identity template could take the form of an adjacency matrix that represents a user's movement through a space. For example, in FIG. 1, the identity template could contain information retrieved from the user's access card, such as encrypted digital certificate data of the user's name, height, age, office location, and movement data pertaining to the user entering the space through door F 112, followed by sequential authentications at doors E 110, B 104, C 106, D 108, E 110, B 104, D 108, G 114 and H 116. Such data may be stored using, for example the HMAC-SHA256 cryptography standard to hash the card number along with the facility code.

In an embodiment, the system generates a template representation of a user's badging events using an adjacency matrix for the user's path, as described. In a naïve implementation process, a system would represent said adjacency matrix as a two-dimensional array, with matrix operations having computational complexity to calculate the edit distance equal to O(n²), where “n” is the total number of access points in a facility. Such operations would require significant resources for computation and storage.

The system described herein overcomes such challenges. Although the number of vertices in a matrix (i.e. access points) may be in the hundreds, each user's movement through a secured facility has significantly fewer connected vertices, frequently less than 10% of the total number of access points. Thus, a user's access point data is a sparse adjacency matrix and can be represented more efficiently using a coordinate format where for each A(i,j)≠0, the triple (i,j,A(i,j)) is stored in memory. Several options may be available for ordering these triples, including unordered, row ordered (i.e., keeping coordinates ordered with respect to row indices only), or row-major order (i.e., keeping coordinates ordered first according to row indices and then according to their column indices). The overall computational complexity remains O(n²). However, in computing a user's movement as a sparse matrix, the system computes “n” as the number of entry points the user walks through, and thus requires fewer resources than if “n” is defined as the total number of entry points a facility.

In another embodiment, the processor instructs a storage unit to store the access point data for later retrieval and analysis.

In another embodiment, an identity template is created in the group context, based on an aggregate of data in a data set, such as encrypted digital certificate data received from users belonging to the same group (e.g., users working in the same office). This group identity template may be used to verify whether a user belongs to the group that the user is trying to enter by establishing a distance compared to an aggregated perspective of someone belonging to a particular group. For example, if an unverified user attempts to use an authorized user's contactless smart card to enter the locked offices of an organization (i.e., the “controlled resource”), the processor receives the unverified user's authentication sequence as the user moves through the space and comes in contact with access points, generates an identity template and compares that user's identity template with the identity template of the group stationed at that office to determine the degree of similarity. If an anomaly is detected (i.e., low similarity), the system restricts access to the controlled resource.

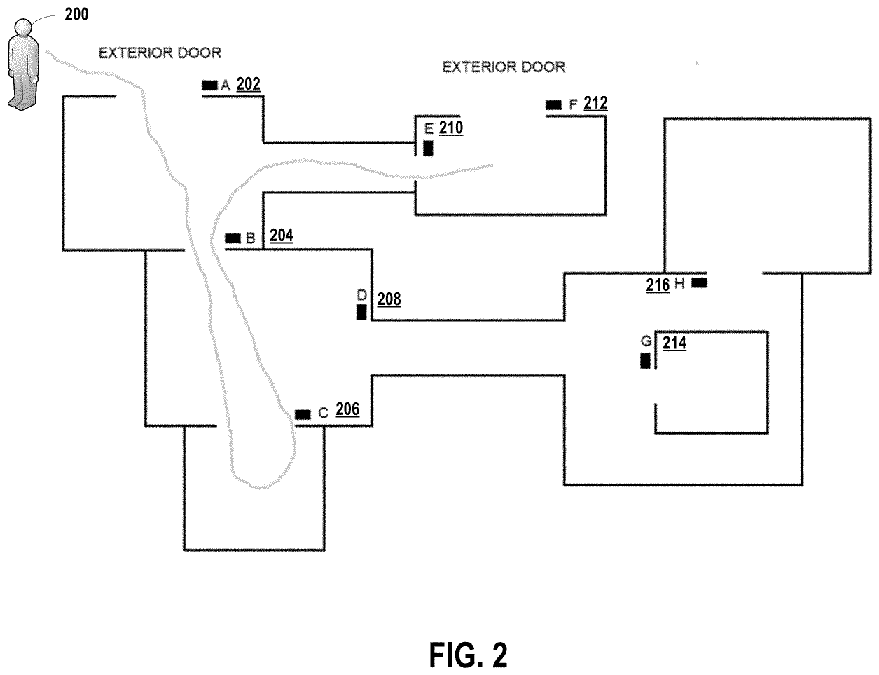

FIG. 2 is a block schematic diagram of a second example user's movements throughout a day, according to some embodiments.

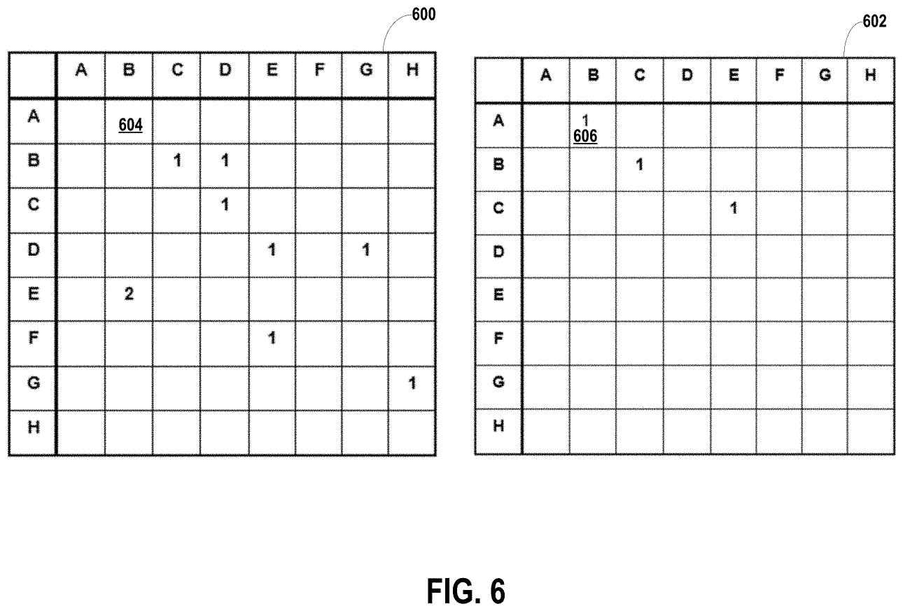

In an embodiment, the system engages a comparison engine to compare a user's current motions with that user's prior motions captured by an identity template, from for example, the day before, and which may be stored on a storage unit, in order to establish whether the user's current motions are similar enough with the user's prior motions for the user to be the same persor, or alternatively, if an intruder is attempting to enter a restricted space. The comparison engine receives the user's current motions from the central administration engine and instructs a template generation engine to generate a challenge template, in or near real time. Once the challenge template is generated, a comparison of the degree of similarity between the identity template and the challenge template is conducted by a comparison engine using a distance matrix algorithm to compute the edit distance between templates. This process is described further in FIG. 6.

In another embodiment, if the system establishes that the challenge template is sufficiently dissimilar from the identity template because it is not within a bounded threshold of similarity, the system employs the processor to generate a control signal restricting access to the controlled resource in or near real time.

In another embodiment, the system generates a control signal restricting access to the controlled resource and invokes a step-up authentication for the unknown user based on a separate authentication modality. For example, the step-up authentication procedure could require that the user input a pin into their cell phone or present for biometric security screening (e.g., fingerprint scan), amongst others.

In an embodiment, the bounded threshold is a pre-selected degree of allowable dissimilarity.

The system provides a technical solution to a technical problem by providing a computational heuristic that allows for the determination of whether a user attempting to access a restrictive space is behaving as expected in or near real time to the user requesting access to said restricted space. The system provides for a computationally efficient method to predict the likelihood of a lost of stolen authentication badge, such as a contactless smart card.

In another embodiment, in addition to comparing a user's movements in a challenge template against the user's historical movements logged in an identity template, the system may rely on further information in addition to a user's pattern of movement through a space, such as for example, the user's preferred exterior door for entry onto the premises (which tends to stay constant in typical users over time) or preferred cafeteria on the user's floor (determined by assessing the frequency with which the user has historically visited one cafeteria over another), for the purpose of assessing the user's fidelity score.

For example, user A may be an individual who walks to work every day. In walking to work, since door A is closest to user A's walking path, user A always enters her workplace through door A every day around the same time. Door A requires badge authentication. Upon arrival at work, user A always goes straight to the elevators, where she taps her badge at the elevator access terminal in order to gain access to her floor (otherwise restricted to the public). Upon arriving at her floor, user A always taps her badge at the same one of three doors to access her office. The system collects information about user A's access requests at each access point: door A, the elevators, and the office door, and analyses user A's fidelity score. The system generates a high fidelity score for user A, since her access request behaviour is consistent over time.

In contrast, user B may be an individual who has access to two different busses to get to and from work. On some days, user B takes bus A and disembarks in front of door A, takes the elevators to his floor, and taps his badge on one of three doors that lead to his office, without consistency. On other days, user B takes bus B and disembarks in front of door B, takes the elevators to his floor, and taps his badge on one of three doors that lead to his office, without consistency. The system collects the same type of information from user B as user A, but generates a low fidelity score for user B because his access request behaviour is inconsistent over time. Fidelity score, for example, can be inversely proportional to the standard deviation aggregated from values in the adjacency matrix as it is updated over time.

Accordingly, a fidelity score can be determined based on a standard of deviation as the adjacency matrix data structure corresponding to the identity template is updated over a period of time, and the edit distance or the bounded threshold can be normalized based on the fidelity score. The fidelity score can thus be used as a mechanism to tune the system to provide greater leeway where there is variation. This tuning, however, comes at the cost of reducing overall security.

In an embodiment, a user's fidelity score is be used to draw conclusions about the level of fidelity of the user's movement patterns and to detect anomalies. For example, FIG. 2 shows an unverified user 200 making use of an authorized user's contactless smart card in an attempt to enter a controlled resource, such as a cafeteria space restricted to employees of a firm. In or near real time, the system receives the unverified user's 200 authentication sequence as the user moves through the space and comes in contact with access points A 202, B 204, C 206, and E 210. In or near real time, the system receiving the data set comprising, for example encrypted digital certificate data (e.g., individual name, time stamps, door reader access events, challenge success etc.) from a central administration engine, analyzes said data and generates a challenge template. The system then compares the challenge template against the authorized user's identity template and determines whether the unverified user should be granted access through the access point in or near real time.

In another embodiment, any difference in movement patterns would be assessed with regard to the user's fidelity score. For user A, having a high fidelity score in the example above, the system would apply a higher similarity threshold (i.e., requiring high similarity between the template and challenge adjacency matrices) in assessing whether an anomaly exist than for user B, having a low fidelity score in the example above.

In another embodiment, a user's fidelity score can be used to implement adaptive authentication, whereby the system assesses the level and type of authentication required at run time, in or near real time, based on the user's fidelity score. For example, the system may label users with high fidelity scores as low-risk and allow them to proceed through an entry point with little authentication requirements. One example of a low authentication requirement protocol may involve the use of camera surveillance technology for user identification and authentication. Conversely, the system may require that users with low fidelity scores engage with active authentication protocols, such as tapping a keycard or a fob at an access point. Users with the lowest fidelity scores will require multiple factors of authentication, for example tapping a card at an access point and entering a pin number sent to the user's mobile phone. Users with extremely low values of fidelity scores may prompt alerts and notifications in the system, as they may indicate a risk event in progress. The levels of fidelity scores presented herein are only meant as examples and should not be understood to be an exhaustive listing of the risk levels available for analysis by the system.

Similarly, in FIG. 2, based on the differences in movement between the authorized user 100 in FIG. 1 and the unverified user 200 in FIG. 2, the system would disallow the unverified user from entering the cafeteria.

In another embodiment, for users with inconsistent movement patterns, like user B in the example above, the system would identify false positives by imposing a lower similarity threshold requirement than for users with highly consistent movement patterns.

In another embodiment, in computing a user's fidelity score, the system uses a formula whereby the fidelity score is a number that corresponds to the similarity between a user's historical authentication data (comparison user) for a set period of time and recent authentication data of a user of interest (UOI) for a period of time of the same length. A low user_prediction_score means that the two patterns of authentication are more similar to each other. The user_prediction_score is calculated by assessing the similarity between the UOI and all of the users in the database that have enough historical data, with the goal of having the predicted user be the same as who the UOI actually is, confirming that there are no unusual access events.

In another embodiment, for example, the user_prediction_score may be calculated as follows:

user_prediction_score=edit_dist+(10*week_sched_diff)+(0.5*start_time_diff)+(0.2*end_time_diff)+(entrance_door_diff)+(2*avg_walk_diff)+(2*avg_unique_door_diff)+(2*total_unique_door_diff)

In the formula above, each element of the user_prediction_score may be weighted according to the significance it has in predicting which the similarity between users. In an example scenario, the following may be true:
(a) edit_dist is the edit distance between the two weighted directed graphs that are being compared, namely the weighted graph of a comparison user and the weighted graph of the UOI;
(b) week_sched_diff is a measure of the difference between the two week-schedules that are being compared. Each week schedule informs the system of which weekdays a user came into work and how many times they came in on that day, for a time window of interest;
(c) start_time_diff is the difference between the typical start time of a shift for the historical data of the comparison user and the typical start time of a shift for the UOI.
(d) end_time_diff is the difference between the typical end time of a shift for the historical data of the comparison user and the typical end time of a shift for the UOI.
(e) entrance_door_diff is a measure of the difference between the two lists of entrance doors being compared. Each list of entrance doors contains the names of the doors that were used by the comparison user to enter the building at the beginning of their shift.
(f) avg_walk_diff is the difference between the average walk length (per shift) of the comparison user and the walk of the UOI. A walk is simply the number of doors a user goes through each shift.
(g) avg_unique_door_diff is the difference between average number of unique doors (per shift) for the comparison user and the UOI.
(h) total_unique_door_diff is the difference between the total number of unique doors for the comparison user and the UOI

In another embodiment, the formula above may be calibrated based on the available historical data of the organization (as topology of access control points varies significantly between organizations).

In another embodiment, the system compares the unverified user's challenge template against the identity template of a group of users that are clustered into groups based on similarity, such as similarity in movement behavior. For example, in the example in FIG. 2, instead of, or in addition to, the unverified user's challenge template being compared against the authorized user's identity template, the system may compare the challenge template against a group template generated by analyzing the movements of a subset of users that use the cafeteria that the unverified user is attempting to enter (1:n), or against all users within the organization (1:m). The comparison would be conducted by the system employing a processor using a distance matrix algorithm to compute the edit distance between templates.

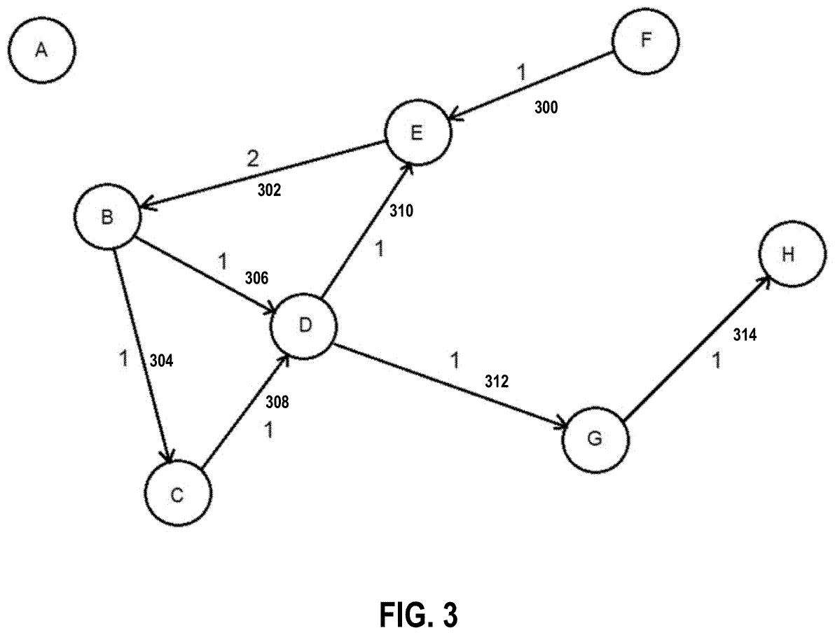

FIG. 3 is a weighted directed graph of an example user's movement throughout the day, according to some embodiments.

In an embodiment, the system uses formal notation from graph theory to represent an authorized user's movements in FIG. 1 by employing a weighted graph generation engine to compute a weighted directed graph G=(V, E) where V is a set of vertices (v1,v2)∈E each corresponding to access control points and E is a set of ordered pairs of vertices established if and only if an individual can travel between two access control points without authenticating at any other access control points. The graph is used to generate a walk along some of the edges established across the nodes of the weighted graph.

In an embodiment, access control points may be, for example, the doors within a controlled resource, amongst others.

For example, the walk shown in FIG. 1 may be represented as the sequence: FEBCDEBDGH, which the system may transform into a weighted directed graph wherein the user's movement from door F to E is assigned a weight of 1 because it only occurred once 300, from door E to B is assigned a weight of 2 because it occurred twice 302, from B to C is assigned a weight of 1 because it only occurred once 304, from B to D is assigned a weight of 1 because it only occurred once 306, from C to D is assigned a weight of 1 because it only occurred once 308, from D to E is assigned a weight of 1 because it only occurred once 310, from D to G is assigned a weight of 1 because it only occurred once 312, and from G to H is assigned a weight of 1 because it only occurred once 314.

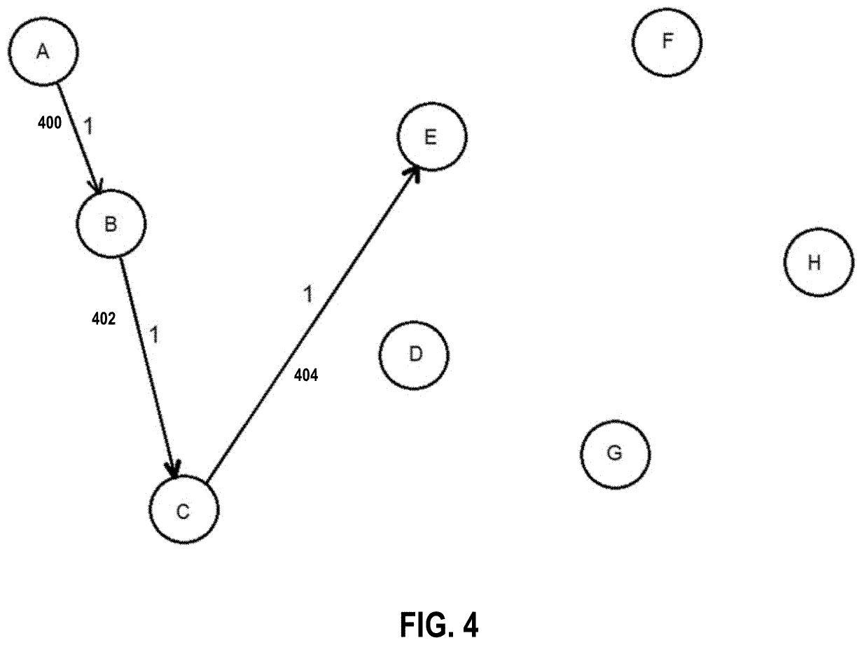

FIG. 4 is a weighted directed graph of a second example user's movement throughout the day, according to some embodiments.

In an embodiment, the system uses formal notation from graph theory to represent an unverified user's movements in FIG. 2 by employing weighted graph generation engine to compute a weighted directed graph.

For example, the walk shown in FIG. 2 may be represented as the sequence: ABCE, which is transformed into a weighted directed graph where the user's movement from door A to B is assigned a weight of 1 because it only occurred once 400, from B to C is assigned a weight of 1 because it only occurred once 402, and from C to E is assigned a weight of 1 because it only occurred once 404.

In an embodiment the system employs an algorithm comprising weighted graph inputs (generated using access point entry data) and similarity matrix outputs to analyze the weighted directed graphs in example FIGS. 3 and 4. The similarity matrix outputs may take the form of distance functions, which are functions used to assess similarities between two graphs based on the distance between pairs of elements within the graphs. For example, the system would compare the weighted graph sequence in FIG. 4, ABCE, representing the challenge template, against the weighted graph sequence in FIG. 3, FEBCDEBDGH, representing the identity template. Upon analysis using a processor employing an arithmetic logic unit, the system would determine that the two templates differ by a factor of 11 units, as described in more detail in FIG. 6.

Traditional approaches to evaluating graph similarity include graph isomorphism, feature extraction, and iterative methods. Unlike the weighted graph method employed by the system, each of these methods has severe drawbacks. For instance, a major disadvantage to using graph isomorphisms is that the exact versions of the algorithm run in exponential time and are therefore not computationally feasible except for very small datasets. The feature similarity approach is based on extracting graph attributes such as degree distribution, diameter, eigenvalues, etc. While this method scales well, it often produces results which are not intuitive. Iterative methods are based on the idea that two vertices are similar if their neighbourhoods are also similar. This method may also lead to results which are not intuitive and it is difficult to come up with a comparison measure that satisfies the criteria of being a distance metric.

The system provided herein discloses a technical solution to the technical problems that these alternative methods face. The system disclosed herein is different from the above and provides fast computational performance as well as a metric of comparison that can be used as a valid distance metric.

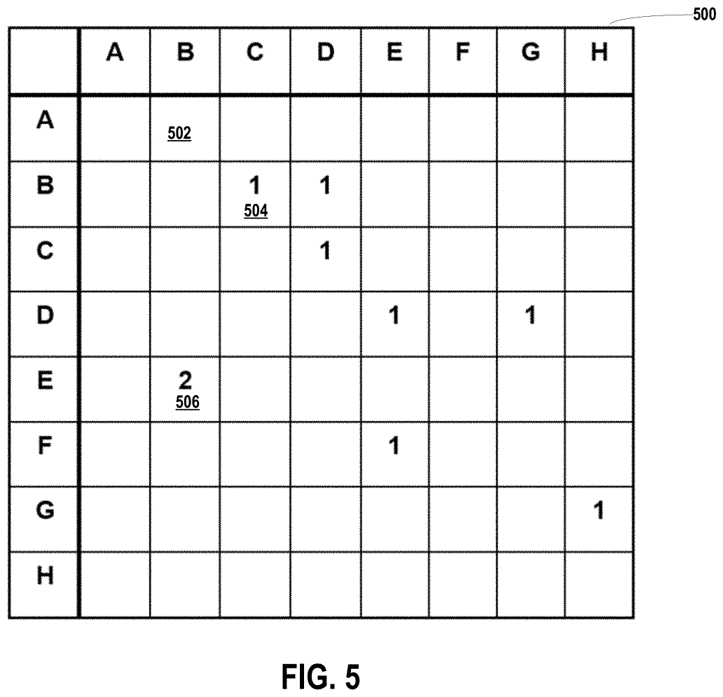

FIG. 5 is a diagram of an adjacency matrix, according to some embodiments.

In an embodiment, the system employs an adjacency matrix generation engine to notate the weighted directed graph displayed in FIGS. 3 and 4 using an adjacency matrix 500, sometimes referred to as a “footprint”, ‘footprint template’ or ‘biometric footprint template’.

In another embodiment, the system transforms a weighted directed graph into an adjacency matrix in order to compute the level of similarity between a challenge template and an identity or group template. The adjacency matrix is created by plotting a table (i.e., a two dimentional array) of vertices wherein each cell represents a potential edge from vertex vᵢ to vertex vⱼ. The value in the cell is zero if the edge (vi, vj) does not exist and is greater than zero if the edge exists. The integer value in the cell is the weight of the edge.

For example, in an embodiment, the system may transform data captured in weighted graph form in FIG. 3 into an adjacency matrix through the use of an adjacency matrix generation engine. In this example, the authorized user's movements may be represented as the sequence: FEBCDEBDGH. Referring back to FIG. 3, the system may create a weighted directed graph of a user's identity template wherein the user's movement from door F to E is assigned a weight of 1 because it only occurred once 300, from door E to B is assigned a weight of 2 because it occurred twice 302, from B to C is assigned a weight of 1 because it only occurred once 304, from B to D is assigned a weight of 1 because it only occurred once 306, from C to D is assigned a weight of 1 because it only occurred once 308, from D to E is assigned a weight of 1 because it only occurred once 310, from D to G is assigned a weight of 1 because it only occurred once 312, and from G to H is assigned a weight of 1 because it only occurred once 314.

In an embodiment, in FIG. 5, an 8×8 adjacency matrix 500 is built via an adjacency matrix generation engine each cell is assigned a value based on the respective weight derived from the weight directed graph. For example, cell A-B 502 is assigned a value of 0 because the user in FIG. 3 did not ever enter door B following an exit through door A. In contrast, cell B-C 504 is assigned a value of 1 because the user in FIG. 3 entered door C following an exit through door B once. For comparison purposes, cell E-B 506 is assigned a value of 2 because the user entered door B following an exit through door E twice over the course of the movement set recorded in the user's identity template. The same analysis would apply for a challenge template or group template.

One advantage to representing physical movement through space using an adjacency matrix is that the matrix captures a user's behavior while using a notation that is precise, intuitive and easier (more computationally efficient) to compare than the raw data. Footprints are a passive behavioural biometric where the adjancy matrix serves as a biometric template.

The storage requirements for a footprint are a quadratic function of the number of vertices in a graph (in bytes). For example, if a facility has a 100 doors then the size of a template would be 10,000 bytes or 10 kb. A more efficient implementation could be achieved as well, since these are sparce matrices and they can be effectively compressed. One way to store a sparce matrix is as a list of lists, storing one list per row, with each entry being the column index and a value. Alternatively a sparce adjancy matrix may be stored as a list of just (row, column, value) tuples. Sorting by row index and then column index also improves access times.

Compressional approaches, for example, can represent series of consecutive zeroes as a single data element, among others, or when creating a population level approach, numbers may be rounded and numbers below a certain threshold can be considered zeroes for computational purposes (e.g., 0.05).

FIG. 6 is an example of two adjacency matrices that can be compared using the system, according to some embodiments.

As mentioned above, the system provided herein discloses a technical solution to the technical problems otherwise encountered when employing traditional approaches to evaluating graph similarity, such as graph isomorphism, feature extraction, and iterative methods. The system disclosed herein is different from the above and provides fast computational performance as well as a metric of comparison that can be used as a valid distance metric. The disclosed method of establishing a formal notation for physical movement through space allows for effective computation of the degree of similarity between different people's movement and behaviour as well as comparison of a person's current data sample (behavioral biometric sample of movement through space) with previous data or data of a group.

In an embodiment, the degree of similarity between two footprints may be analyzed by computing the edit distance between adjacency matrices. For example, FIG. 6 presents the two adjacency matrices representing graphs illustrated in FIG. 3 and FIG. 4.

In another embodiment, the system employs an arithmetic logic unit to measure the degree of similarity between the two graphs in FIG. 6 through calculating the edit distance between those graphs using a formula such as:

$${\sum }_{i , j} \vert A [ i , j ] - B [ i , j ] \vert$$

In the example presented in FIG. 6, the system compares the values ascribed to each cell between the two graps. For instance, the FEBCDEBDGH graph 600 at cell AB 604 has a value of 0 because the user in FIG. 1 did not ever enter door B following an exit from door A. In contrast, the ABCE graph 602 at cell AB 606 has a value of 1 because the user in FIG. 2 entered door B following an exit from door A once. The system assesses such differences for the entirety of this example 8×8 adjacency matrix. Thus, in this example, the resulting value is calculated as:

|0−1|+|1−1|+|1−0|+|1−0|+|0−1|+|1−0|+|1−0|+|2−0|+|1−0|+|1−0|=11

In other words, the degree of similarity between the two adjacency matrix is a function of distance (walk_{FEBCDEBDGH}, walk_{ABCE})=11.

In the example above, if x, y, and z are three different footprints, the distance function defined above is a valid distance metric since it satisfies the three criteria of a distance metric:

d(x,x)=0

d(x,y)=d(y,x)

d(x,z)<=d(x,y)+d(y,z)

The degree of similarity between any of the shifts and any of the users may be calculated using this distance metric.

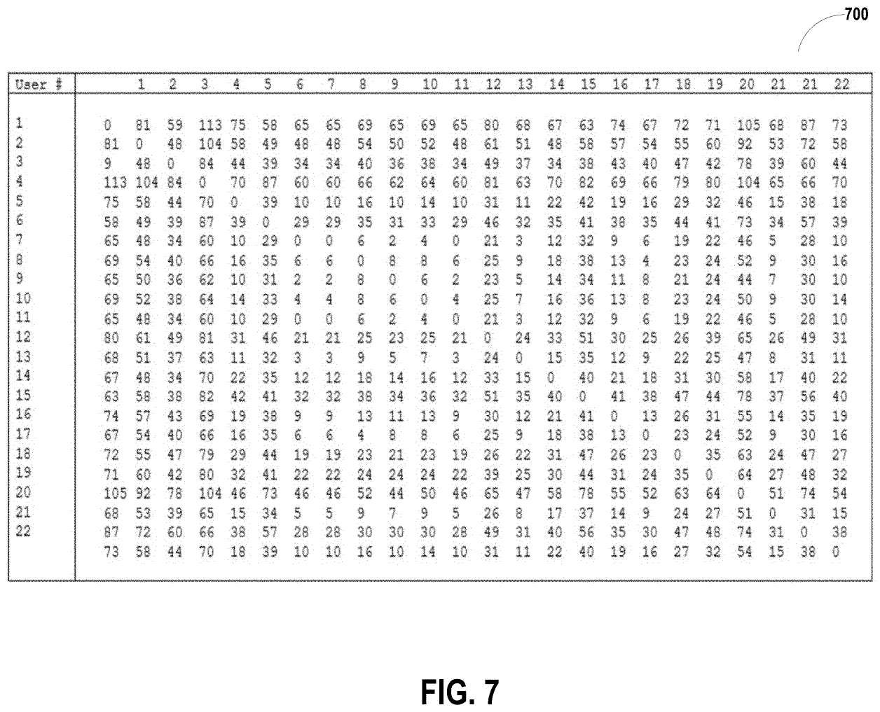

In an embodiment, there are at least two specific approaches that may be taken to calculate the distance metric. In one approach, the system may compute distances between different users or groups of users. In another approach, the system may compare a user's current work shift to historical shift and generate alerts (risk events) when a predefined threshold is exceeded. Each of these approaches is discussed in more detail in FIG. 7 below.

FIG. 7 is an example adjacency matrix 700 of the computed distance between users, according to some embodiments.

In an embodiment, the system compares a user's most recent challenge template to that user's existing identity template comprising of access and movement data collected in earlier periods, such as the day before or earlier the same day. A configurable parameter such as HistoryDuration may be used to specify how far back in time to look at historical data for comparison purposes. In experimental results, using 6 weeks provided enough data to generate about 20-30 templates per person. The system generates an average adjacency matrix by averaging the values in those templates.

In an embodiment, for example, the system may retrieve 3 shifts for one user in the HistoryDuration interval, as represented below with matrices A, B, and C:

$$[ \begin{matrix}{a}_{11} & … & {a}_{1 n} \\ ⋮ & ⋱ & ⋮ \\ {a}_{n 1} & … & {a}_{nn}\end{matrix} ] [ \begin{matrix}{b}_{11} & … & {b}_{1 n} \\ ⋮ & ⋱ & ⋮ \\ {b}_{n 1} & … & {b}_{nn}\end{matrix} ] [ \begin{matrix}{c}_{11} & … & {c}_{1 n} \\ ⋮ & ⋱ & ⋮ \\ {c}_{n 1} & … & {c}_{nn}\end{matrix} ]$$

The system may generate an average matrix for comparison against the user's most recent matrix generated from the user's most recent challenge template:

$$[ \begin{matrix}avg ( {a}_{11} , {b}_{11} , {c}_{11} ) & … & avg ( {a}_{1 n} , {b}_{1 n} , {c}_{1 n} ) \\ ⋮ & ⋱ & ⋮ \\ avg ( {a}_{n 1} , {b}_{n 1} , {c}_{n 1} ) & … & avg ( {a}_{nn} , {b}_{nn} , {c}_{nn} )\end{matrix} ]$$

The system may retrieve as many shifts for any one user as requested using the HistoryDuration interval, and the same averaging would apply to create a new average matrix from historical data. For example, if the HistoryDuration time interval function is set to retrieve 20 shifts, the system would use the same approach to generate a matrix with average values out of 20 historical matrices.

Once an average adjacency matrix is derived, the system compares this matrix to the adjancy matrix for the most current shift (derived from the most current challenge template) of the same user by using an edit distance function, as shown in FIG. 6.

The resulting value is a similarity score that may then be compared to a preconfigured threshold to assess whether the instance is an anomaly. If the threshold value is exceeded, then the distance is greater than allowed and a risk event is generated. A risk event is any type of outlier in user behavior that is raised or generated when an anomaly is detected. Following a risk event, the system communicates with a central administration engine to restrict access to the controlled resource or require that the user engage in step-up authentication, such as inputting a pin received on the user's mobile phone or having the user's fingerprint scanned at the access point.

In another embodiment, a user's challenge template and the adjacency matrix derivered therein may be compared to the respective adjacency matrices of other users within a group or all other uses in an organization to identify the closest neighbour. In this use case, each pair of users is compared and the distance between their footprints is computed to assess similarity.

The example adjacency matrix in FIG. 7 shows experimental results of the computed distance between 24 users 700. In this example, some cells have a value of 0, showing that there is no different in movement pattern between the two users with respect to that particular access point, while other cells show a value of over 100, suggesting significant difference in movement pattern with respect to that point (i.e., an “anomaly”).

The disclosure herein provides a system having the ability to compute distances between footprints of different users and assess the degree of similarity between different users' access behaviors. More importantly, the disclosure provides a system and method to detect anomalies in the user's access behavior and generates alerts or even block access to a restricted space where an anomaly is detected.

The ability to compare users' movement through space using a distance metric enables the system to cluster users based on similarity seen in their behavior. For example, it is typical for individuals who work on the same team to exhibit similar behavior, such as coming to work at the same time, using the same entry or exit doors, or accessing the same facilities. Knowing which group an individual is most similar to is useful in detecting anomalies. For example, in FIG. 6, instead of comparing the adjacency matrix created from the challenge template of one user against that same user's adjacency matrix created from the user's earlier identity template, the system could compare the former against the adjacency matrix of a group of which that user is part. This clustering approach allows group or population level comparisons by replacing the 1:n or 1:m comparison with a 1:1 comparison against the corresponding population or group level template that has been built over time or built on demand. Accordingly, the complexity and magnitude of the computation and the amount of computational time required can be reduced through continuous updating of the corresponding template data structures, distributing the computational load across a period of time as opposed to conducting a large number of comparisons all at once when required.

For example, in an embodiment, a new employee would be provided with a fob key containing encrypted digital certificate data for that user, such as name, job title and office location. Through the user's job title and office location, the system could infer the specific group of individual to whom that user would be most similar. If that user is in sales, for example, the system expects that the user's movement pattern within the organization would be most similar to that of other on the same sales team. The new user would not have any historical movement data against which to compare the user's challenge template to assess whether the user is to be permitted entrance into certain areas of the organization. Instead, the system may employ a processor running an agglomerative clustering algorithm to assess the new user's similarity in movement patterns against those of the group to which the user belongs.

Currently available clustering methods, such as k-means algorithms, have inherent limitations that the system disclosed herein resolves. For instance, in order to cluster people into groups based on similarity, k-means algorithms rely on a knowledge of the number of clusters in which those users are to be placed and that a Euclidean distance metric be used. Both of these assumptions do not hold true when clustering users into groups of similar movement patterns because it is not possible to know “k”, the number of clusters, before forming the teams or groups based on similarity. Furthermore, the system described herein does not deal with a metric space, meaning that a Euclidean distance function does not exist.

In an embodiment, the system disclosed herein provides a technical solution to the technical problem described above by applying an agglomerative clustering algorithm. Unlike k-means algorithms, the agglomerative clustering algorithm does not require that the number of clusters be known ahead of time ahead of time and accepts direct input of the footprint distance metric defined in FIG. 6 as a custom distance function. The agglomerative clustering algorithm begins by treating each object as a singleton cluster. The algorithm computes similarity information between each pair of singleton clusters and merges them into hierarchical cluster trees using linkage functions. The result is a dendrogram showing linkages between former singleton clusters.

In the example above, the agglomerative clustering algorithm would recognize that the new user's movement pattern is most similar to that of other users on the sales team.

Since the user's encrypted digital certificate data confirms that the user is in fact on the sales team, the system would proceed to grant access into an otherwise restricted area.

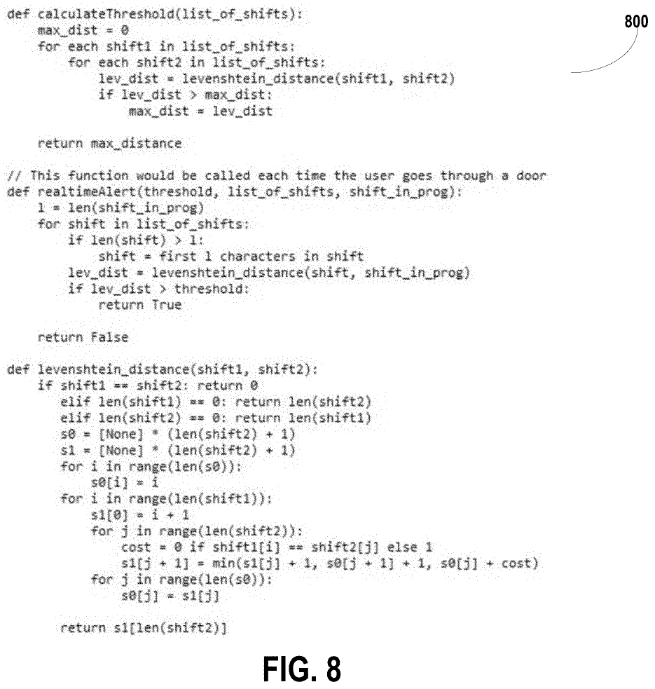

FIG. 8 is an example algorithm used to detect anomalies in or near real time, according to some embodiments.

As mentioned elsewhere, the disclosure provided herein assesses anomalies in user movement patterns based on a comparison of the user's footprints, as extracted from, for example, daily work shift data.

In an embodiment, the system described herein employs an arithmetic logic unit to calculate Levenshtein distances between strings representing daily shifts and detect anomalies before a work shift is completed, providing in or near real time feedback regarding whether a particular user may or may not enter a restricted area.

In another embodiment, the Levenshtein distance between strings representing daily shifts is defined as the minimum number of single-character edits (i.e., insertions, deletions, or substitutions) required to change one word into the other. Once the Levenshtein distance exceeds a certain threshold, the system may raise an alert disallowing the user from entering the premises, regardless of how much daily data has been collected from said user thus far.

For example, in another embodiment, a user's daily authentication patterns are represented by these sequences:

| | |
|---|---|
| Shift 1 (S₁) = ABCBCBCD | complete shift |
| Shift 2 (S₂) = ABCBBCD | complete shift |
| Shift 3 (S₃) = ABBCBCBCD | complete shift |
| Shift 4 (S₄) = AEFEF... | shift in progress |
| Levenshtein Distance (S₁, S₂) = 1 | |
| Levenshtein Distance (S₂, S₃) = 4 | |
| Levenshtein Distance (S₃, S₄) = 8 | |

In the sequence above, the user's latest shift (i.e., shift 4) is still in progress, but the system, employing an algorithmic logic unit to perform the Levenshtein distance calculation in or near real time, assesses the distance between shifts 3 and 4 as being equal to 8. If, for example, the threshold for Levenshtein distance is set to 6, the system interprets (S₃,S₄)=8 to indicate that there is significant discrepancy in the user's behavior compared to their previous shift. The system would flag this as an anomaly.

The Levenshtein distance algorithm 800 used to detect anomalies is shown in FIG. 8.

It is important to select an appropriate threshold for comparison. In an embodiment, the Levenshtein distance algorithm threshold is selected as the largest value previously recorded as the difference between shifts for the particular user.

In another embodiment, when a new shift is being processed, the system calculates the Levenshtein distance based on an algorithm, such as the algorithm shown in FIG. 8, between the user's current shift in progress and the use's historical shifts. The minimum value is then selected by the system and compared to a pre-established threshold. If this minimum value is in excess of the threshold, the system generates an alert that notifies an administrator of the atypical behavior detected.

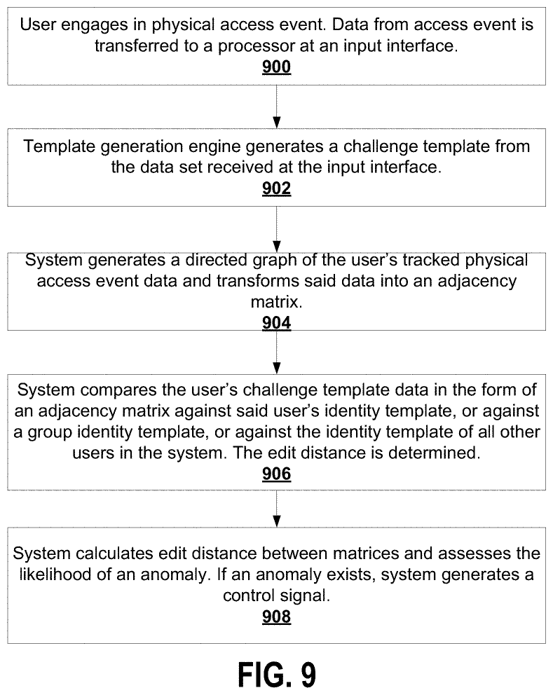

FIG. 9 is a method diagram describing the method by which the system detects anomalies, according to some embodiments.

At 900, a user engages in a tracked physical access event, such as tapping a badge against a badge reader terminal. In an embodiment, on proximity, the terminal transfers encrypted digital certificate data in the form of a data set to a central administration engine via, for example, NFC technology. A processor within the central administration engine transfers the data set, to a second processor at an input interface.

At 902, The second processor instructs a template generation engine to generate a challenge template from the data set received at the input interface.

At 904, the system generates a directed graph of the user's tracked physical access event data, which is then transformed into an adjacency matrix.

At 906, the system compares the user's challenge template, now in the form of an adjacency matrix, against said user's identity template (created as described before), or against a group identity template, or against the identity template of all other users in the system (altogether, “baseline”), all in the form of adjacency matrices. The edit distance is calculated using a formula, such as:

$${\sum }_{i , j} \vert A [ i , j ] - B [ i , j ] \vert$$

At 908, upon determining the edit distance, the system compares the edit distance with a pre-selected threshold to determine whether the user's movement patterns are sufficiently similar to baseline that the user is likely who they purport to be. If an anomaly is detected (i.e., a value higher than threshold, meaning low similarity), the system generates a control signal restricting access to the controlled resource or requires the user to engage in further step-up authentication.

In an embodiment, in addition to computing the edit distance between footprints, the system uses a fidelity score to assess the similarity between a user's historical authentication data for a set period of time and recent authentication data, as described above.

In another embodiment, the system is able to detect anomalies in or near real time using, for example, a Levenshtein distance algorithm, as described above.

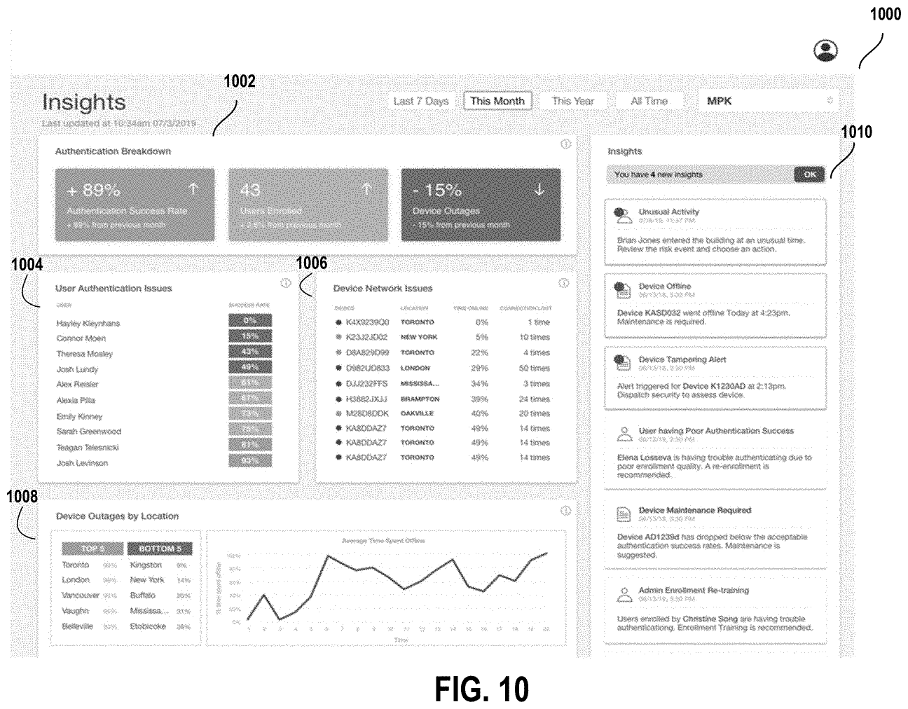

FIG. 10 is a graphical rendering of an administrative interface 1000, according to some embodiments.

In an embodiment, an administrative interface 1000 comprises of one or more dynamically rendered user interface modalities, each modality representing a separate modality, including: authentication breakdown 1002, user authentication issues 1004, device network issues 1006, device outages by location 1008, and insights 1010.

In another embodiment, the authentication breakdown 1002 modality presents information regarding, for example, overall authentication success rate based on all the access requests in an organization, the number of users enrolled for an organization, device outages (e.g., access point devices that are experiencing technical difficulties).

In another embodiment, the user authentication issues 1004 modality presents information regarding the success rate of specific users using gaining access to the access points they are requesting access to.

In another embodiment, the device network issues 1006 modality presents information regarding access points within the organization (e.g., doors equipped with access terminals are requiring that users present a badge prior to being granted access through that door) that are experiencing technical difficulties.

In another embodiment, the device outages by location 1008 modality presents information regarding an organization's device outages per office location. For instance, if an organization has offices in Toronto, London, Kingston and New York, the system presents device outage information per office, drawing an administrator's attention to the locations in which device outages are more prevalent.

In another embodiment, the insights 1010 modality presents summary information about, for example, urgent issues that an administrator must resolve, such as unusual activity or devices that are offline in or near real time.

In another embodiment, an administrator uses information presented in the administrative interface in the form of dynamically rendered user interface modalities to determine whether a user should be suspended access, whether step-up authentication should be requested of the user, or if an alert should be ignored.

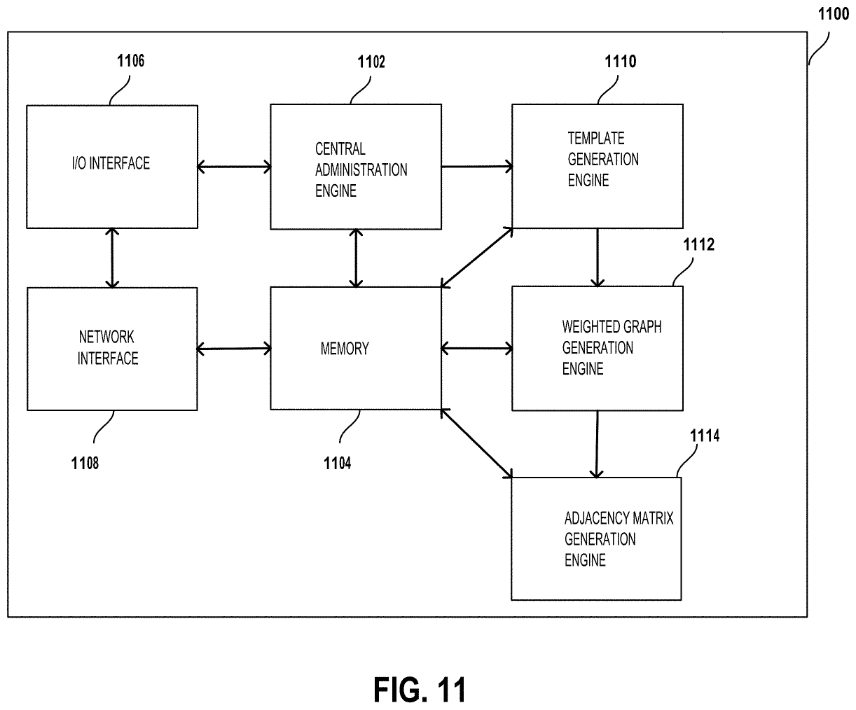

FIG. 11 is a block schematic diagram of an example computing device 1100, according to some embodiments. As depicted, computing device 1100 includes at least one central administration engine 1102, memory 1104, at least one I/O interface 1106, at least one network interface 1108, at least one template generation engine 1110, at least one weighted graph generation engine 1112, and at least one adjacency matrix generation engine 1114.

Each central administration engine 1102, template generation engine 1110, weighted graph generation engine 1112, and adjacency matrix generation engine 1114 may be, for example, microprocessors or microcontrollers, a digital signal processing (DSP) processor, an integrated circuit, a field programmable gate array (FPGA), a reconfigurable processor, a programmable read-only memory (PROM), thereof.

Memory 1104 may include computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

Each I/O interface 1106 enables computing device 1100 to interconnect with one or more input devices, such as a keyboard, mouse, camera, touch screen and a microphone, or with one or more output devices such as a display screen and a speaker.

Each network interface 1108 enables computing device 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., WMAX), SS7 signaling network, fixed line, local area network, wide area network, and others, including any combination of these.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations may be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A system for controlling access to a controlled resource using tracked physical access events, the system comprising a processor operating in conjunction with computer memory, the processor configured to:
receive, at an input interface, a first data set indicative of tracked physical access events associated with a user or a group of users;
generate an identity template from the first data set associated with the user or the group of users;
receive, at the input interface, a second data set indicative of tracked physical access events associated with an unverified user;
generate a challenge template from the second data set;
determine a degree of similarity between the identity template and the challenge template; and
upon determining that the degree of similarity is not within a bounded threshold, generate a control signal restricting access to the controlled resource.

2. The system of claim 1, wherein the processor, in generating the identity template or the generating of the challenge template generates a corresponding weighted directed graph G=(V,E) where V is a set of vertices each corresponding to access control points and E is a set of ordered pairs of vertices established if and only if an individual can travel between two access control points without authenticating at any other access control points.

3. The system of claim 2, wherein the processor, in generating the identity template updates weights of the edges E based on the first data set representing one or more walks undertaken by the user or the group of users in traversing the access control points represented by the vertices, based on the corresponding weighted directed graph; and wherein the processor, in generating the challenge template updates weights of the edges E of the corresponding weighted directed graph based on the second data set representing one or more walks undertaken by the unverified user.

4. The system of claim 3, wherein the weighted directed graphs are stored as adjacency matrix data structures; and
wherein the processor, in determining the degree of similarity, determines an edit distance between the adjacency matrix data structure corresponding to the identity template and the adjacency matrix data structure corresponding to the challenge template.

5. The system of claim 4, wherein the edit distance is determined based at least on a Levenshtein distance.

6. The system of claim 3, wherein the corresponding walk is generated based on one or more sequences of badging events.

7. The system of claim 1, wherein the first data set and the second data set include at least one data field representative of individual name, time stamps, door reader access events, or challenge success.

8. The system of claim 1, wherein the physical access events include at least one of door access, motion sensor triggers, or geolocation-based events.

9. The system of claim 1, wherein the control signal restricting access to the controlled resource invokes a step-up authentication for the unknown user based on a separate authentication modality.

10. The system of claim 5, wherein the processor is further configured to determine a fidelity score based on a standard of deviation as the adjacency matrix data structure corresponding to the identity template is updated over a period of time, and to normalize the distance or the bounded threshold based on the fidelity score.

11. A method for controlling access to a controlled resource using tracked physical access events, the method comprising:
receiving, at an input interface, a first data set indicative of tracked physical access events associated with a user or a group of users;
generating an identity template from the first data set associated with the user or the group of users;
receiving, at the input interface, a second data set indicative of tracked physical access events associated with an unverified user;
generating a challenge template from the second data set;
determining a degree of similarity between the identity template and the challenge template; and
upon determining that the degree of similarity is not within a bounded threshold, generating a control signal restricting access to the controlled resource.

12. The method of claim 11, wherein the generating of the identity template or the generating of the challenge template includes generating a corresponding weighted directed graph G=(V,E) where V is a set of vertices each corresponding to access control points and E is a set of ordered pairs of vertices established if and only if an individual can travel between two access control points without authenticating at any other access control points.

13. The method of claim 12, wherein the generating of the identity template includes updating weights of the edges E based on the first data set representing one or more walks undertaken by the user or the group of users in traversing the access control points represented by the vertices, based on the corresponding weighted directed graph; and wherein the generating of the challenge template includes updating weights of the edges E of the corresponding weighted directed graph based on the second data set representing one or more walks undertaken by the unverified user.

14. The method of claim 13, wherein the weighted directed graphs are stored as adjacency matrix data structures; and
wherein determining the degree of similarity includes determining an edit distance between the adjacency matrix data structure corresponding to the identity template and the adjacency matrix data structure corresponding to the challenge template.

15. The method of claim 14, wherein the edit distance is determined based at least on a Levenshtein distance.

16. The method of claim 13, wherein the corresponding walk is generated based on one or more sequences of badging events.

17. The method of claim 11, wherein the first data set and the second data set include at least one data field representative of individual name, time stamps, door reader access events, or challenge success.

18. The method of claim 11, wherein the physical access events include at least one of door access, motion sensor triggers, or geolocation-based events.

19. The method of claim 11, wherein the control signal restricting access to the controlled resource invokes a step-up authentication for the unknown user based on a separate authentication modality.

20. A non-transitory computer readable medium, storing machine interpretable instructions, which when executed by a processor, cause the processor to perform a method for controlling access to a controlled resource using tracked physical access events, the method comprising:
receiving, at an input interface, a first data set indicative of tracked physical access events associated with a user or a group of users;
generating an identity template from the first data set associated with the user or the group of users;
receiving, at the input interface, a second data set indicative of tracked physical access events associated with an unverified user;
generating a challenge template from the second data set;
determining a degree of similarity between the identity template and the challenge template; and
upon determining that the degree of similarity is not within a bounded threshold, generating a control signal restricting access to the controlled resource.
